(19) United States
(12) Patent Application Publication
(10) Pub. No.: US 2017/0340493 A1
(43) Pub. Date: Nov. 30, 2017

(54) VEHICLE MOUNTED STOWABLE ACCESS RAMP

(71) Applicants: Gurshan Singh Sidhu, Richmond, CA (US); Rupinder Singh Sidhu, Richmond, CA (US)

(72) Inventors: Gurshan Singh Sidhu, Richmond, CA (US); Rupinder Singh Sidhu, Richmond, CA (US)

(21) Appl. No.: 15/612,359

(22) Filed: Jun. 2, 2017

(30) Foreign Application Priority Data
Apr. 8, 2016 (CA) 2926417

(51) Int. Cl. A61G 3/06; B60P 1/43

(52) U.S. Cl. CPC A61G 3/062; B60P 1/435

(57) ABSTRACT

Methods and systems for stowing and extending a stowable access ramp mounted to a wheelchair accessible vehicle are disclosed. One such system includes a stowable ramp extendable between a stacked position and an extended position. The ramp includes an upper panel for forming an upper part of the ramp, a mid panel for forming a middle part of the ramp, and a lower panel for forming a lower portion of the ramp. The mid panel is hingedly coupled to the upper panel for pivoting the mid panel into ramp alignment with the upper panel during extension of the ramp and the lower ramp is hingedly coupled to the mid panel for pivoting the lower panel into ramp alignment with the mid panel during extension of the ramp. The upper panel, mid panel, and lower panel stack atop each other for stowing in the stacked position.

### TECHNICAL FIELD

The present disclosure relates to vehicle mounted access ramps. More particularly, the present disclosure is directed to systems and methods for compactly stowing a wheelchair access ramp in a wheelchair accessible vehicle.

### BACKGROUND

Wheelchair accessible vehicles have become increasingly common in the last few decades. Most public transport vehicles are now accessible to wheelchairs. Some smaller buses are specifically designed to transport people with disabilities. Additionally, most taxi fleets include wheelchair accessible vehicles. Private vehicle owners with disabled family members also make use of wheelchair accessible vehicles.

Smaller vehicles, such as vans, are often modified to make them wheelchair accessible. The modifications include adding access doors that provide access all the way to the floor of the vehicle. Access doors may be located at the rear of the vehicle or on the side. Ramps or powered lifts are used for bringing the wheelchair into the vehicle.

Ramps and lifts are generally stowed inside the vehicle when they are not in use. Ramps are usually stowed upright adjacent a door or flat on the floor of the vehicle. When needed, they are deployed either by rolling them out or pivoting them into position. Ramps may be folded in two when stowed. They may be power operated or manually operated.

There exists a continuing desire to advance and improve technology related to vehicle mounted access ramps.

### SUMMARY

In accordance with an illustrative embodiment of the disclosure, there is provided a stowable ramp for providing wheelchair access to a vehicle. The stowable ramp may be extendable between a stacked position and an extended position extending from an entry port of the vehicle to an outside surface. The ramp includes an upper panel for forming an upper part of the ramp. The upper panel includes a vehicle coupling element for coupling the upper panel to the vehicle at the entry port. The ramp also includes a mid panel for forming a middle part of the ramp. The mid panel is hingedly coupled to the upper panel for pivoting the mid panel into ramp alignment with the upper panel during extension of the ramp. The ramp further includes a lower panel for forming a lower portion of the ramp. The lower panel is hingedly coupled to the mid panel for pivoting the lower panel into ramp alignment with the mid panel during extension of the ramp. At least two of the upper panel, the mid panel, and the lower panel are coupled to rotation limiters for limiting rotation of the upper panel, the mid panel, and the lower panel collectively between the stacked position and the extended position and wherein the upper panel, mid panel, and lower panel stack atop each other for stowing in the stacked position.

The stowable ramp may also include a first hinge positioned between adjacent ends of the upper panel and the mid panel for hingedly coupling the upper panel to the mid panel and a second hinge positioned between adjacent ends of the mid panel and the lower panel for hingedly coupling the mid panel to the lower panel.

The stowable ramp in the stacked position may be stowable in an upright position relative to a floor of the vehicle. In the upright position, a bottom planar surface of the upper panel faces the entry port.

The rotation limiters may include an abutting portion of the lower panel for abutting against an abutting portion of the mid panel when the ramp is in the extended position.

The rotation limiters may include a projection extending from the mid panel for bearing against a surface of the lower panel when the ramp is in the extended position.

The rotation limiters may include a projection extending from the lower panel for bearing against a surface of the mid panel when the ramp is in the extended position.

Each of the upper panel, the mid panel, and the lower panel may be coupled on either side to one or more side rails. Each side rail extends vertically upwards relative to a top planar surface of the panel that the side rail is coupled to such that the ramp in the extended position has side rails on either side for impeding a wheel of a wheelchair from rolling off of a side of the ramp.

The rotation limiters may include an end piece of the one or more side rails coupled to the mid panel. The end piece is adjacent to the lower panel when the ramp is in the extended position and the end piece has a load bearing surface for bearing against a complimentary load bearing surface of a complimentary end piece on a side rail of the lower panel when the ramp is in the extended position.

The end piece may be thickened relative to a mid portion of the one or more side rails coupled to the mid panel and the complimentary end piece may be thickened relative to a mid portion of the one or more side rails coupled to the lower panel, thereby increasing surface areas of the load bearing surface and the complimentary load bearing surface.

The load bearing surface may be located on an extension of the end piece. The extension may be received in a slot in the complimentary end piece when the ramp is in the extended position.

The upper panel may include a slot on either side adjacent to an inner side of the one or more side rails for receiving the one or more side rails of the mid panel when the ramp is in the stacked position.

The rotation limiters may include a support coupling element on the upper panel spaced apart from the vehicle coupling element for receiving a support to support the upper panel in the extended position.

The rotation limiters may include a second vehicle coupling element on the upper panel spaced apart from the vehicle coupling element for rigidly fixing the upper panel to the vehicle entry port.

The upper panel may be rigidly fixable via the vehicle coupling element to a lower access gate of the vehicle at the entry port such that the ramp in the stacked position is stacked on the lower access gate and moveable in conjunction with the lower access gate between a position corresponding to the extended position of the upper panel and a position that is an upright position relative to the floor of the vehicle.

The rotation limiters may include a support leg coupled to the upper panel for supporting the ramp in the extended position. A distal portion of the support leg contacts the ground when the ramp is in the extended position.

The mid panel may include multiple panels, each of the multiple panels hingedly coupled to an adjacent panel.

The stowable ramp may be foldable into the stacked position by pivoting the lower panel and the mid panel around a first axis at which the upper panel is hingedly coupled to the mid panel and pivoting the lower panel around a second axis at which the lower panel is hingedly coupled to the mid panel such that in the stacked position, a bottom face of the lower panel is adjacent a bottom face of the mid panel and a top face of the mid panel is adjacent a top face of the upper panel.

The lower panel may be coupled to a handle for pulling the ramp into the extended position.

In accordance with another illustrative embodiment of the disclosure, there is provided a system for providing wheelchair access to a vehicle for transporting passengers in wheelchairs or scooters. The system includes a vehicle comprising a passenger compartment for receiving a passenger in a wheelchair and an entry port for providing a passenger in a wheelchair entry into and out of the vehicle. The system also includes a stowable ramp mountable at the entry port for providing wheelchair access to a vehicle. The stowable ramp may be extendable between a stacked position and an extended position extending from an entry port of the vehicle to an outside surface. The ramp includes an upper panel for forming an upper part of the ramp. The upper panel includes a vehicle coupling element for coupling the upper panel to the vehicle at the entry port. The ramp also includes a mid panel for forming a middle part of the ramp. The mid panel is hingedly coupled to the upper panel for pivoting the mid panel into ramp alignment with the upper panel during extension of the ramp. The ramp further includes a lower panel for forming a lower portion of the ramp. The lower panel is hingedly coupled to the mid panel for pivoting the lower panel into ramp alignment with the mid panel during extension of the ramp. At least two of the upper panel, the mid panel, and the lower panel are coupled to rotation limiters for limiting rotation of the upper panel, the mid panel, and the lower panel collectively between the stacked position and the extended position and wherein the upper panel, mid panel, and lower panel stack atop each other for stowing in the stacked position.

Thy system may include a lower access gate at the entry port, the lower access gate openable downwards, and the stowable ramp may be mounted to the lower access gate such that the ramp in the stacked position is stacked on the lower access gate and moveable in conjunction with the lower access gate between a position corresponding to the extended position of the upper panel and a position that is an upright position relative to the floor of the vehicle.

In accordance with another illustrative embodiment of the disclosure, there is provided a method for extending a wheelchair access ramp from a stacked position in a vehicle to an extended position extending from an entry port of the vehicle to an exterior surface. The method includes pivoting a stack of ramp panels from an upright position to a lowered position, the stack comprising a mid panel between an upper panel and a lower panel, the upper panel being positioned closest to a floor of the vehicle and having a bottom planar surface facing towards the floor of the vehicle in the lowered position. The mid panel is coupled to the upper panel at a first end and to the lower panel at a second end and the upper panel is coupled to the vehicle at a vehicle coupling position distal to the first end. The method also includes rotating the lower panel around a pivoted joint that couples the lower panel to the mid panel and rotating both the lower panel and the mid panel around a pivoting joint that couples the mid panel to the upper panel until top surfaces of all three panels are aligned to form a ramp extending from the vehicle to the exterior surface. Rotation limiters coupled to two or more of the ramp panels maintain the ramp in the extended position by limiting rotation of the ramp panels from the upright position to the extended position.

The rotation limiters may include an upper panel support spaced apart from the vehicle coupling position for supporting the upper panel in the lowered position.

The rotation limiters may include a rotation limiting portion of the mid panel and a rotation limiting portion of the lower panel, the rotation limiting portion of the mid panel engaging with the rotation limiting portion of the lower panel for limiting rotation of the lower panel between the lowered position and the extended position.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments,

FIG. 1A is an isometric view of a stowable ramp in a stacked position mounted to the rear of a vehicle;

FIG. 1B is an isometric view of the stowable ramp of FIG. 1A in an extended position;

FIG. 2 shows a stowable ramp at a position between the stacked position and the extended position;

FIG. 3 is a bottom view of a stowable ramp in an extended position;

FIG. 4 is a front view of a stowable ramp stowed in an upright position in a vehicle;

FIG. 5 is a is a side view of a stowable ramp in an extended position with support legs attached to the stowable ramp;

FIG. 6 shows a stackable ramp with attached side rails;

FIG. 7 is a partial view of a stowable ramp showing the end pieces of side rails on a lower panel and a mid panel; and

FIG. 8 shows a block diagram of a method for deploying a stowable ramp mounted to the interior side of a lower access gate of a wheelchair accessible vehicle.

### DETAILED DESCRIPTION

Directional terms such as “top”, “bottom”, “upper”, “lower”, “left”, “right”, and “vertical” are used in the following description for the purpose of providing relative reference only, and are not intended to suggest any limitations on how any article is to be positioned during use, or to be mounted in an assembly or relative to an environment unless otherwise stated. Additionally, the term “couple” and variants of it such as “coupled”, “couples”, and “coupling” as used in this description are intended to include indirect and direct connections unless otherwise indicated. For example, if a first device is coupled to a second device, that coupling may be through a direct connection or through an indirect connection via other devices and connections.

Vehicle mounted access ramps generally have the ramps stowed inside the vehicle when the ramp is not in use. It is desirable to stow the ramps in a compact position to increase useable space inside the vehicle. Some ramps are stowed on the floor of the vehicle and slid or rolled into position for use. However, regulations and guidelines concerning length to height ratios often dictate the length of a ramp. Therefore, it may not always be feasible to stow a full length ramp inside a vehicle, since the ramp's length may be longer than the available space.

Ramps are also often stowed in an upright position adjacent a door of a vehicle. In an upright or standing position, a top surface of the ramp (the top surface is the surface that a wheelchair will roll on), is positioned generally parallel or at a slight angle to the door it is adjacent, with the axis of the ramp oriented at or close to vertical relative to the vehicle. Ramps stowed in an upright position are generally bi-fold ramps. Bi-fold ramps are made of two ramp pieces joined together at a hinge and are stowed in a folded position.

The vertical profile of a ramp stored in an upright position may be high enough to hinder easy access to the interior space of the vehicle through the door that the ramp is adjacent. For example, a user trying to load groceries into a van through a rear door with a wheelchair access ramp stowed next to it may need to lower the ramp or attempt to squeeze packages in the space between the roof of the vehicle and the top of the ramp. A ramp stowed in an upright position at a rear door may also hamper a driver's view.

In the present disclosure, a stowable ramp that may be folded along two parallel axes is provided. This ramp may be stowed as a stack of three ramp pieces or panels. Rotation around the two parallel axes may be limited to hold the three pieces in ramp shape when the ramp is extended. Support pieces may be used to provide additional strength at the joints between the pieces to decrease the likelihood of buckling. Unlike methods and systems used in the prior art, the methods and apparatus of the present disclosure provide for a ramp that may be stowed in a stack of three pieces. When stowed in an upright position, this ramp may have a smaller vertical profile than a bi-fold ramp, increasing accessibility to the interior of the vehicle as well as visibility through a window adjacent the stowed ramp. Additionally, this ramp may vibrate less when the vehicle is being driven, creating less noise and possible damage to the ramp and the vehicle, when stowed in the upright position as compared to bi-fold ramps and ramps stowed along or under the floor of the vehicle.

Although the access ramps in the present disclosure are generally discussed with reference to providing wheelchair access, the access ramps may provide access for various types of passengers and items, including but not limited to scooters for the elderly and disabled and wheelchairs.

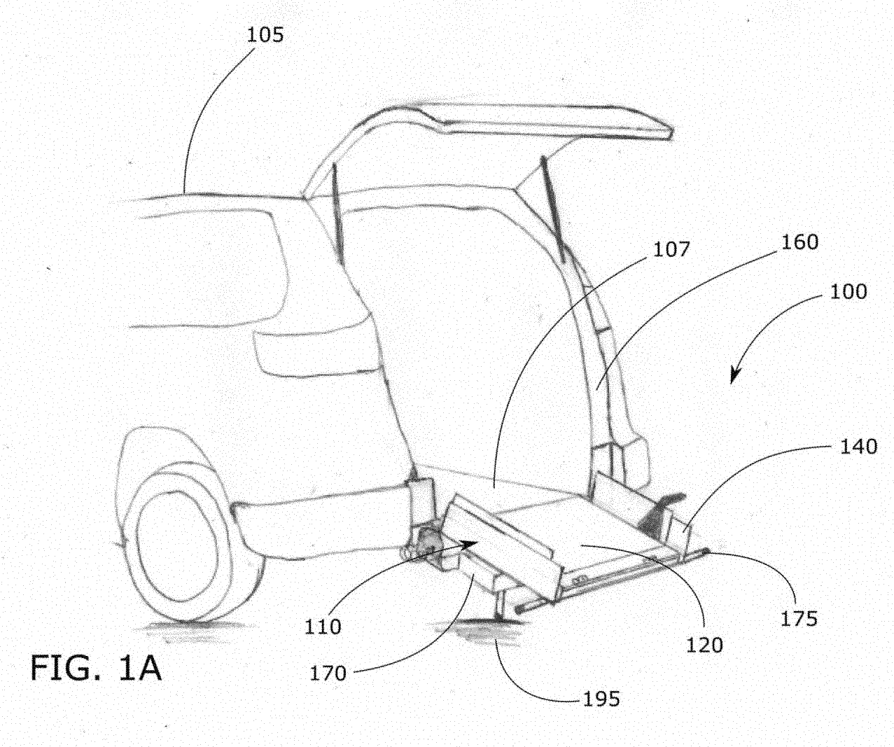

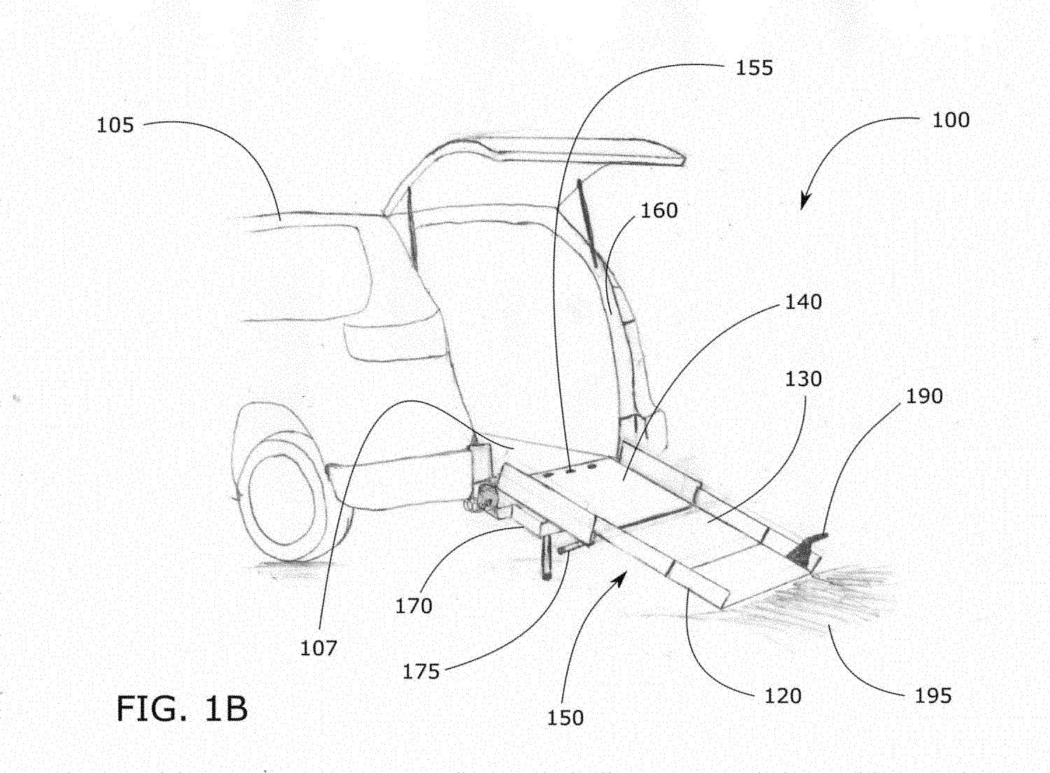

Referring to FIGS. 1A and 1B, an embodiment of a stowable ramp 100 for providing wheelchair access to a vehicle 105 is shown. The stowable ramp 100 is extendable between a stacked position 110 and an extended position 150 extending from an entry port 160 of the vehicle 105 to an outside surface 195. The outside surface 195 is any surface outside the vehicle 105 that a wheelchair will roll onto the ramp 100 from. The stowable ramp 100 may be mountable at the entry port 160.

The ramp 100 includes an upper panel 140 for forming an upper part of the ramp 100, a mid panel 130 for forming a middle part of the ramp 100, and a lower panel 120 for forming a lower part of the ramp 100. The mid panel 130 may be hingedly coupled to the upper panel 140 for pivoting the mid panel 130 into ramp alignment with the upper panel 140 during extension of the ramp 100. Similarly, the lower panel 120 may be hingedly coupled to the mid panel 130 for pivoting the lower panel 120 into ramp alignment with the mid panel 130 during extension of the ramp 100.

The term ramp alignment is used to refer to the alignment of adjacent panels when that alignment corresponds to the alignment of the extended ramp 150. For example, to be in ramp alignment, planes extending from adjacent edges of the top surfaces (the surface on which the wheelchair will roll) of adjacent panels may be in planar alignment or they may positioned so that the planes extending from adjacent edges of the top surfaces of adjacent panels include an acute intersection angle of between about 0° to about 10°. Any two adjacent panels may be in ramp alignment without the ramp being in the extended position. For example, the lower panel may be in ramp alignment with the mid panel but they may not be in ramp alignment with the upper panel. In some embodiments, the surfaces of the ramp panels may include curved portions.

Referring again to FIGS. 1A and 1B, in certain embodiments, the upper panel 140, the mid panel 130, and the lower panel 120 stack atop each other for stowing in the stacked position 110. In the stacked position 110, the planar surfaces of the panels may be parallel to each other. In some embodiments, the planar surfaces of the panels may be offset from the parallel by 0° to 10°. The ramp axes of the panels may also be parallel or, in some embodiments, within 10° of parallel to each other. The ramp axis for each panel is an axis oriented along the length of the ramp 100 when the ramp 100 is in the extended position 150.

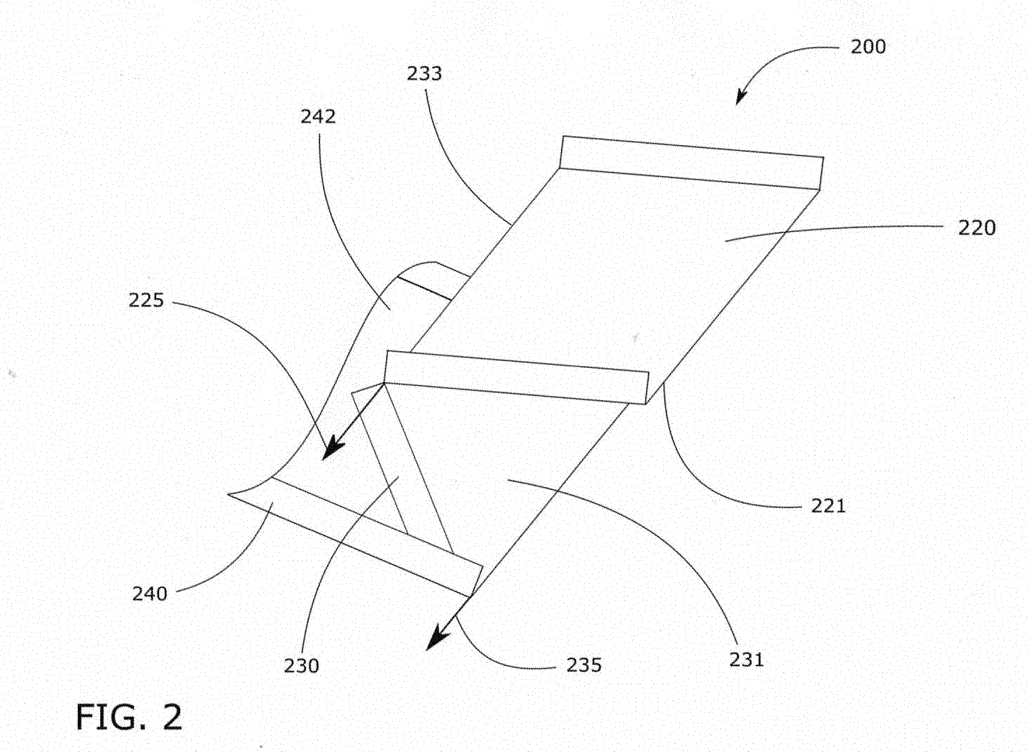

Referring to FIG. 2, a ramp 200 is shown at a position somewhere between a stacked position and an extended position. In some embodiments, the ramp 200 may be foldable into the stacked position from the extended position and unfoldable into the extended position from the stacked position. For example, in certain embodiments, the ramp 200 may be foldable into the stacked position by pivoting the lower panel 220 and the mid panel 230 around a first axis 235 at which the upper panel 240 is hingedly coupled to the mid panel 230 and pivoting the lower panel 220 around a second axis 225 at which the lower panel 220 is hingedly coupled to the mid panel 230 such that in the stacked position, a bottom face 221 of the lower panel 220 is adjacent a bottom face 231 of the mid panel 230 and a top face 233 of the mid panel 230 is adjacent a top face 242 of the upper panel 240. The terms bottom face, bottom planar surface, and bottom surface are used interchangeably ad refer to the underside surface of the panels or the ramp when the ramp is in the extended position. Similarly, the terms top face, top planar surface, and top surface are used interchangeably and refer to the top surface of the panels or the ramp when the ramp is in the extended position. The top face is the surface that a wheelchair will traverse when the ramp is in use.

Hingedly coupled refers to the panels being coupled in a manner to permit rotation of one panel relative to the other panel around a single axis that is parallel to the coupling ends (adjacent ends) of the panels. For example, in FIG. 2, the mid panel 230 is capable of rotation around the axis 235 that is adjacent and generally parallel to the end of the upper panel 240 that is closest to the mid panel 230.

In certain embodiments, the stowable ramp may include a pivoting joint coupled to adjacent ends of the upper panel and the mid panel and to adjacent ends of the mid panel and the lower panel. In some embodiments, the stowable ramp may include a first hinge positioned between adjacent ends of the upper panel and the mid panel for hingedly coupling the upper panel to the mid panel and a second hinge positioned between adjacent ends of the mid panel and the lower panel for hingedly coupling the mid panel to the lower panel.

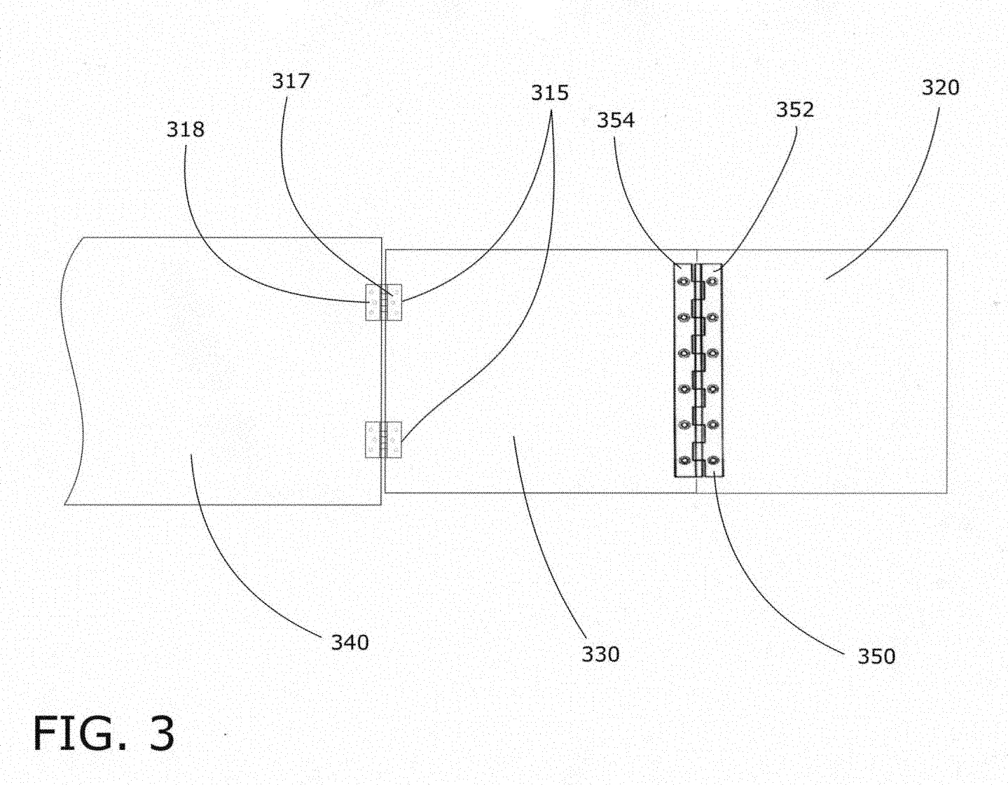

Any suitable pivoting joint or hinge may be used to hingedly couple adjacent panels. For example, referring to FIG. 3, one or more butt hinges 315, each including two plates 317, 318 or leaves coupled by a metal rod running through the hinge barrel formed between them, may be used to hingedly connect the upper panel 340 to the mid panel 330. One of the plates 317, 318 or leaves may be fastened to the bottom surface of the upper panel 340 and one of the plates 317, 318 or leaves may be fastened to the bottom surface of the mid panel 330. Any suitable fastening method may be used to fasten the plates or leaves to the panels. For example, in some embodiments, the plates or leaves may be riveted, bolted, or welded to the panels. Bolt holes, screw holes, or rivet holes may be counter bored on the top surface of the panels to keep bolts, screws, or rivets from protruding above the panel surfaces.

As shown in FIG. 3, in some embodiments, a continuous (piano style) hinge 350 may be used to hingedly couple, for example, the mid panel 330 to the lower panel 320. The continuous hinge 350 may extend along about 50% to about 100% of the length of the edge of the lower panel 320. Each of the two leaves 352, 354 of the continuous hinge 350 may be fastened to the bottom surface of the mid panel 330 and the bottom surface of the lower panel 320, respectively, using any suitable fastening means. The continuous hinge 350 may provide additional strength to the ramp 300 for resisting, for example, buckling, at the coupling axis between the mid panel 330 and the lower panel 320. The strength of the ramp may be mandated to meet certain levels in some jurisdictions. For example, in some jurisdictions, the ramp may have a strength to support a load of 6001b placed at the centroid of the ramp and distributed over an area of 26 inches by 26 inches with a safety factor of at least 3. The hinges used may be of a size and strength to resist failing when the ramp is placed under the aforementioned load.

In certain embodiments, adjacent panels may be hingedly coupled to each other using lapped style pivoting joints. For example, in some embodiments, one or more plates projecting from the end of one panel, oriented so that an axis parallel to the adjacent ends of adjacent panels is perpendicular to a planar face of the projecting plates, overlap similar plates projecting from an end of an adjacent panel, such that holes in the plates are aligned. An annular member, such as rod, pin, or bolt, may pass through the holes in the projecting plates to pivotally couple the panels. The projecting plates may be positioned below the top surface of the panels or at the sides of the panels, with the holes positioned below the top surfaces of each panel so that the annular member is below the top surface. Alternatively, in some embodiments, one panel may include projecting plates with each plate having a hole for receiving a corresponding annular member. The other panel may include the corresponding annular members for mating with the holes in the first panel to create a pivoting joint for hingedly coupling the two panels. In certain embodiments, one panel may include hook shaped projections for receiving an annular member coupled to an adjacent panel. Hooking the annular member in the hook shaped projections may create a pivoting joint for hingedly coupling the adjacent panels.

In some embodiments, adjacent panels may be hingedly coupled using linkages or linking members. For example, a linking member (for example, a bar or a rod) may be pivotally coupled at a first end to a side edge of one panel (for example, the upper panel) and be pivotally coupled at a second end to a side edge of a second panel adjacent the first panel. A second linking member may be similarly coupled to the panels on the opposite sides of the panels (the opposite sides being the side edges located across the width of the ramp). The linking members may allow the adjacent panels to rotate relative to each other.

In some embodiments, the pivoting joints between adjacent panels may be configured to limit rotation of adjacent panels between a stacked position and a ramp alignment position. Any suitable means of limiting rotation may be used. For example, in certain embodiments, a hinge used as the pivoting joint may have an inherent or built-in maximum angle of rotation. In some embodiments, abutting pieces at the joint or on the panels may limit the angle of rotation.

Referring again to FIGS. 1A and 1B, in certain embodiments, at least two of the upper panel 140, the mid panel 130, and the lower panel 120 are coupled to rotation limiters for limiting rotation of the upper panel 140, the mid panel 130, and the lower panel 120 collectively between the stacked position 110 and the extended position 150. Each set of adjacent panels may be limited to rotate between two positions (such as, for example, the stacked position and a ramp alignment position) such that the rotations of all three panels collectively are limited to moving the ramp between the stacked position and the extended position. For example, in some embodiments, the upper panel may be coupled to a support for holding the upper panel in the position required for the ramp to be in the extended position. The support may act as a rotation limiter by limiting rotation of the upper panel around a coupling point of the upper panel with the vehicle. Rotation may be limited such that the upper panel does not rotate below the extended position of the upper panel (the extended position of the upper panel is a position of the upper panel that corresponds to the position of the upper panel when the ramp is in the extended position). The mid panel may be free to rotate around the pivoting joint coupling the upper panel to the mid panel, allowing the mid panel and the lower panel to freely pivot down until a lower edge of the lower panel rests against the ground or other external surface. In these embodiments, one or more rotation limiters may limit rotation of the lower panel relative to the mid panel from the stacked position to a position where the lower panel and the mid panel are in ramp alignment. The lower panel may be free to rotate down, so that the lower edge of the lower panel is free to move towards the ground, but may not be free to rotate upwards past the ramp alignment position. When the ramp is in the extended position, rotation limiters may inhibit upwards rotation of the lower edge and the ground may inhibit downwards rotation of the lower edge of the lower panel.

Any suitable rotation limiters, which include supports or support pieces, may be used for limiting rotation of the upper panel, the mid panel, and the lower panel collectively between the stacked position and the extended position. In certain embodiments, the rotation limiters may include an abutting portion of the lower panel for abutting against an abutting portion of the mid panel when the ramp is in the extended position. For example, in some embodiments, an end edge surface of the lower panel adjacent the mid panel may abut against an adjacent end edge surface of the mid panel when the lower panel and the mid panel are rotated into ramp alignment, thereby inhibiting continued rotation of the lower panel beyond ramp alignment. In these embodiments, the axis that the lower panel pivots around may be located below the abutting edge surfaces. The panels may be thickened at the edges to increase the surface area of the abutting portion. In some embodiments, the rotation limiters may include a projection extending from the lower panel for bearing against a surface of the mid panel when the ramp is in the extended position. Similarly, in some embodiments, the rotation limiters may include a projection extending from the mid panel for bearing against a surface of the lower panel when the ramp is in the extended position. Other rotation limiters may include, for example, a bar or rod extendable from one panel to an adjacent panel for locking the panels into position. The bar or rod may be received in any suitable receiving element on the adjacent panel, such as any suitable groove, slot, hole, or notch.

The minimum strength of the ramp in the extended position may be regulated in some jurisdictions, as mentioned earlier. For example, in some jurisdictions, the ramp may have a strength to support a load of 6001b placed at the centroid of the ramp and distributed over an area of 26 inches by 26 inches with a safety factor of at least 3. In some embodiments, the features of the ramp, including pivoting joints, rotation limiters, and ramp materials may be selected to resist failing when the ramp is placed under the aforementioned load.

The panels of the ramp are shaped and sized to accommodate a wheelchair. The overall length of the ramp may be regulated by law. For example, in some jurisdictions, the length of the ramp should be six times the height from the surface that the lower edge of the ramp rests to the floor of the vehicle that the ramp deploys from. For example, if the floor surface that the ramp deploys from is 9″ above the outside surface that the ramp deploys to, the ramp may have a length of 54″. Each panel may be any suitable length so long as the ramp in the extended position is of a suitable length. For example, in certain embodiments, the length of each panel may be almost equal to each other, with no panel being longer than the upper panel. In some embodiments, the length of the lower panel may be slightly less than the length of the other two panels.

In some embodiments, the mid panel may include multiple panels. In such embodiments, each of the multiple panels may be hingedly coupled to an adjacent panel.

The top planar surface of the panels may have any suitable width for accommodating a wheelchair. In certain embodiments, the width of the panels may be about equal to or slightly less than the width of the entry port. In some embodiments, the width of the panels may be about equal to or slightly less than the width of the floor of the vehicle, so long as the width of the floor is less than or equal to the width of the entry port at floor level. In some embodiments, the panels may have unequal widths relative to each other. For example, the width of the mid panel and the lower panel may be less than the width of the upper panel. Alternatively, in some embodiments, the width of any two or all three panels may be equal to each other.

The thickness of each panel, along with the material forming the panel and the structural shape of each panel, should be suitable for supporting the weight of a passenger in a wheelchair plus an attendant pushing the wheelchair. The strength of a wheelchair access ramp may be regulated by applicable laws. For example, as mentioned above, in some jurisdictions, the ramp may have a suitable structural shape and be made of a suitable material to support a load of 6001b placed at the centroid of the ramp and distributed over an area of 26 inches by 26 inches with a safety factor of at least 3. In some embodiments, each panel may be constructed of a metallic material, such as steel or aluminum. In certain embodiments the panels may be constructed of composite materials, such as, for example, carbon fiber. The panels may have any suitable thickness. For example, in some embodiments, the panels may have a thickness of several millimeters.

Each panel may have a solid surface. In some embodiments, the surface may have cutouts for handholds or latchholds. Alternatively, in certain embodiments, the surface may have additional gaps and holes to reduce the weight of the panel. For example, the panel may be a grating.

The surface of a panel may be smooth. Alternatively, in some embodiments, the surface of a panel may be patterned, non-smooth, or roughened to provide traction or to prevent slippage. Non-slip decals or stickers may also be added to the surface. Additionally, in some embodiments, separators or stoppers may be coupled to the panels to reduce direct contact between the surfaces of the panels in the stacked position. Any suitable separators or stoppers may be used. For example, in certain embodiments, rubber stoppers may be added to the underside of the mid panel or the lower panel to inhibit the panels from striking each other directly. Alternatively, plastic stoppers may be used. In some embodiments, rubber tabs or stoppers may be attached to the sides of the top surface of the mid panel or the upper panel. The addition of stoppers or separators may reduce the possibility of the metallic surfaces of the panels striking each other or rubbing against each other when the ramp is placed in the stacked position. Separators or stoppers may also reduce noise generated from metal striking or rubbing against metal. Additionally, separators or stoppers may reduce vibrations of the stowed ramp when the vehicle is in motion.

Biasing means may also be used to reduce the impact of panels striking each other during the stacking process by slowing down the angular velocity of the panels as they move into the stacked position. Any suitable biasing means may be used. For example, in some embodiments, springs, linkage systems, or pistons may be used to slow down the angular velocity of the mid panel as it rotates into the stacked position. Similar biasing means may also be used to slow the rotation of the panels as the panels rotate into the extended position. In some embodiments, biasing means, including but not limited to springs, linkage systems, or piston based systems, may be used to assist a user in moving the ramp from the stacked position to the extended position or from the extended position to the stacked position by decreasing the force needed by the user to rotate the panels. Biasing means may also be used to hold the ramp in the extended position or the stacked position.

Referring again to FIG. 1B, the lower panel 120 may be coupled to a handle 190 for pulling the ramp 100 into the extended position 150 from the stacked position 110 and moving the ramp 100 into the stacked position 110 from the extended position 150. The handle 190 may be coupled to the lower panel 120 at any suitable position. For example, in certain embodiments, the handle 190 may be coupled to the lower panel 120 at a side of the lower panel 120, proximate to the lower edge (the edge resting against the ground in the extended position). The handle may have any suitable shape. For example, in certain embodiments, the handle may include a connecting member, such as, for example, a plate, flange, or rod, coupled to the lower panel and projecting above the top surface of the lower panel. A gripping portion of the handle may be attached to the connecting member. Any suitable gripping portion may be used. For example, a cylindrical gripping portion may be attached to the connecting member such that the axis running along the axis if the cylindrical gripping portion is oriented at or close to a perpendicular angle to the ramp axis (the axis running along the length of the extended ramp). Alternatively, in some embodiments, a bar shaped gripping portion may be used.

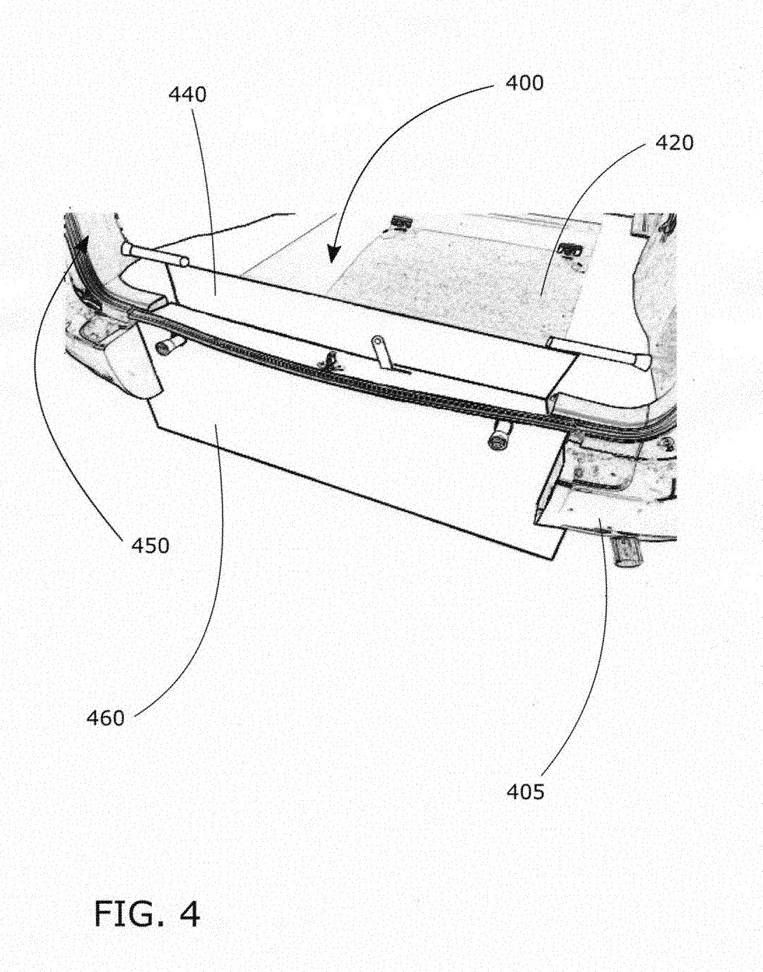

Referring to FIG. 4, an embodiment of the stowable ramp 400 in the stacked position and stowed in an upright position is shown. The stowable ramp 400 in the stacked position may be stowable in an upright position relative to the floor 420 of the vehicle 405. In the upright position, a bottom planar surface of the upper panel 440 faces the entry port 450. In certain embodiments, the ramp may be stowable in a reclined position, with a face of the upper panel horizontal relative to the floor of the vehicle or at a slight angle from the horizontal. Alternatively, in some embodiments, the ramp may be stowable at any suitable angle between a horizontal position and an upright position.

In certain embodiments, the ramp may be stowable inside the vehicle adjacent an entry port at the rear of a vehicle and the ramp may be deployable from the rear entry port. In some embodiments, the ramp may be stowable adjacent an entry port at either one of the sides of a vehicle and the ramp may be deployable from the same side entry port that it is stored adjacent to. Alternatively, in certain embodiments, the ramp may be mounted and stowable on the exterior of the vehicle, adjacent an entry port.

In certain embodiments, the entry port may include a door that opens upwards. In some embodiments, the entry port may include one or more doors that open sideways. Alternatively, the entry port may include sliding doors. The entry port door may extend to the floor of the entry port. The floor of the entry port is the portion of the vehicle floor that is within the entry port. The entry port floor may be contiguous with a floor of the vehicle. The ramp may be deployable from the floor of the entry port.

As shown in FIG. 4, in certain embodiments, the entry port 450 may also include a downwards opening lower access gate 460, such as, for example, a tailgate. The lower access gate 460 may cover a lower portion of the entry port when the lower access gate 460 is closed. In some embodiments, the ramp 400 may be deployed when the lower access gate 460 is open.

The vertical profile of the ramp in the upright position will depend on the lengths of the panels and the mounting position. For example, in some embodiments (not shown), the vertical profile may be such that a topmost portion of the stowed ramp is level with the topmost part of the lower access gate when the gate is in the closed position.

Referring again to FIG. 1B, the upper panel 140 includes a vehicle coupling element 155 for coupling the upper panel 140 to the vehicle 105 at the entry port 160. Any suitable coupling element for coupling the upper panel 140 to the vehicle 105 at the entry port 160 may be used. For example, in certain embodiments, the vehicle coupling element includes bolt holes or rivet holes for attaching the upper panel 140 to an interior facing portion of a downwards opening lower access gate 170 situated at a lower portion of the entry port 160. The upper panel 140 may also be welded to the downwards opening lower access gate 170. In certain embodiments, the stowable ramp may be coupled to both the floor at the entry port 160 and the lower access gate 170.

In some embodiments, the upper panel may be coupled to a floor portion of the entry port using a hinged connection. The hinged connection may allow the upper panel to pivot from an upright position to a lowered position for deployment of the ramp (in the lowered position, the position of the upper panel corresponds to the position of the upper ramp when the ramp is extended—also referred to as the extended position of the upper panel). Any suitable hinge or pivoting joint may be used. For example, one or more external hinges may be attached to the upper ramp and the floor portion of the entry port to allow the upper ramp to pivot with respect to the floor of the vehicle. In some embodiments, annular members, such as shafts or bolts, extending from the side edges of the upper panel may be adapted to fit in receiving holes on the bottom sides of the entry port to create a pinned connection allowing rotation of the upper panel around an axis parallel with the bottom edge of the entry port.

Any suitable holding means may be used to hold the ramp in an upright position. For example, in some embodiments, the ramp may be held in place by a bracket or spring loaded latching system positioned at one of the sides of the entry port. The ramp may be released for lowering from the upright position by releasing the latch. Alternatively, a locking system at a pivoting joint may be used to hold the ramp in the upright position. Alternatively, any suitable locking or latching system may be used to secure or hold the ramp in an upright position when the ramp is not being used. Similarly, any suitable holding means may be used to hold the lower panel in the stacked position when the ramp is in an upright position. For example, in some embodiments, one or more magnets may be used to provide a biasing force for holding the lower panel in the stacked position. The magnets may be coupled to, for example, the bottom surface of the lower panel or the bottom surface of the mid panel.

In certain embodiments, the ramp may be held in place in the upright position by a downwards opening lower access gate. In some embodiments, the ramp may be held in place between the lower access gate and a bracket or holding piece attached to the vehicle at the entry port. As shown in FIG. 1A, the ramp 100 may be coupled to the lower access gate 170 and opening the lower access gate 170 will lower the ramp 100 with the panels in the stacked position 110. In some embodiments, a bottom surface of the upper panel 140 may be rigidly fixable to the lower access gate 170 of the vehicle 105 such that the ramp 100 in the stacked position 110 is stacked on the lower access gate 170 and moveable in conjunction with the lower access gate 170 between a position corresponding to the position of the upper panel 140 when the stowable ramp 100 is in the extended position 150 and a position that is an upright position relative to the floor 107 of the vehicle 105. Any suitable fastening method for rigidly fixing the upper panel 140 to the lower access gate 170 may be used. For example, in some embodiments, the upper panel 140 may be bolted, riveted, screwed, or welded to the lower access gate 170. The fastening method may be used at one or more locations along the upper panel 140.

In some embodiments, the upper panel may have a support coupling element in addition to the vehicle coupling element. The support coupling element may act as a rotation limiter. In certain embodiments, the rotation limiters comprise a support coupling element on the upper panel spaced apart from the vehicle coupling element for receiving a support to support the upper panel in the extended position. The support received at or coupled to the support coupling element may limit the upper panel from rotating down past the extended position. Any suitable support coupling element may be used. For example, in some embodiments, the support coupling element may include a portion of the underside of the upper panel directly adjacent to the vehicle coupling element. The portion of the underside of the upper panel may rest against a bottom or floor portion of the entry port, with the floor portion of the entry port acting as the support coupled to the support coupling element. Coupling in these embodiments includes the upper panel resting against the floor portion. In certain embodiments, the support coupling element may include connectors for attaching supports coupled to a part of the vehicle located above the upper panel when the ramp is in the extended position. For example, rods or bars forming a linkage system may be attached to the upper panel for holding it up. Alternatively, cables or chains may be used to hold the upper panel in position.

In some embodiments, the support coupling element or rotation limiters comprise a second vehicle coupling element on the upper panel spaced apart from the vehicle coupling element. The second vehicle coupling element may be for rigidly fixing the upper panel to the vehicle entry port. For example, the support coupling element may comprise bolt holes with bolts or welds for rigidly fixing the upper panel to, for example, the lower access gate as discussed above.

In some embodiments, the lower access gate may act as a support for the ramp for holding the ramp in position both in the stacked position and the extended position. For example, the lower access gate may not open down further than a position that will hold the upper panel at the level of the extended position. Therefore, the lower access gate may prevent the upper panel from rotating down past the extended position. In some embodiments, the lower access gate will act as a support for the upper panel when in a lowered position even if the upper panel is not coupled to the lower access gate but to the floor at the entry port. In certain embodiments, the upper panel may be pivotally coupled to the lower access gate at an end of the upper panel closest to the entry port. Contact between the lower access gate and a point or portion of the upper panel that is away from the coupled end will provide the upper panel with support to hold it in position when the lower access gate is in an opened or lowered position. The lower access gate may similarly support the upper panel in a lowered or extended position when the upper panel is rigidly fixed to the lower access gate.

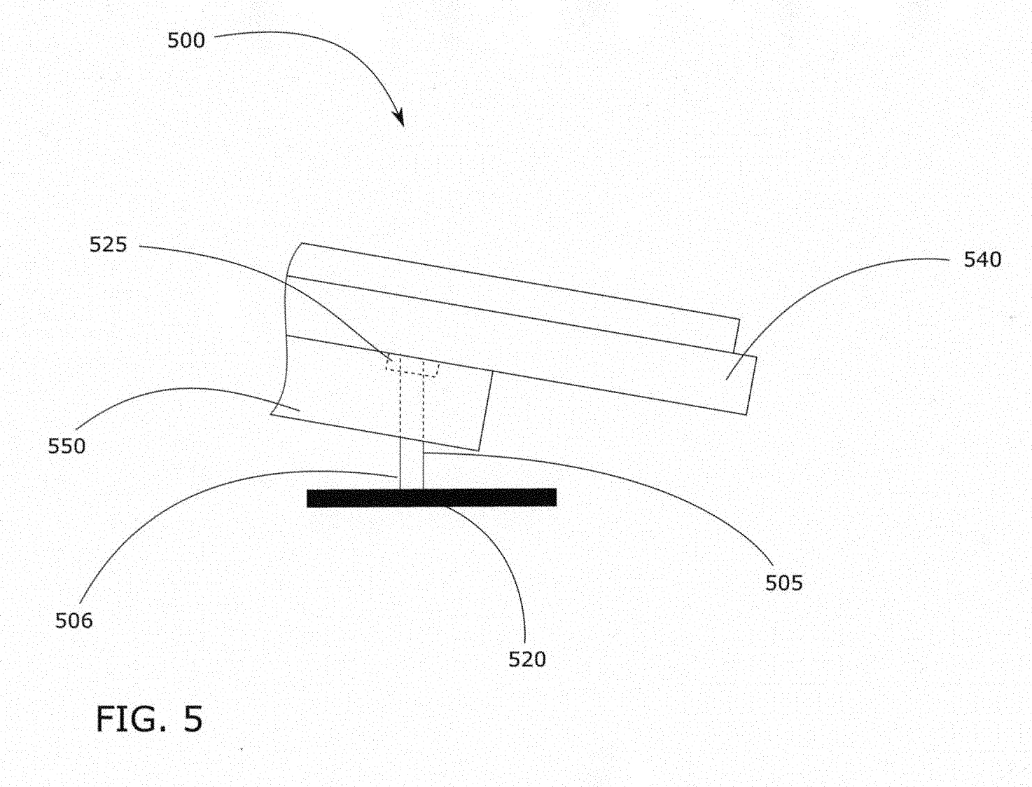

Referring to FIG. 5, a support leg 505 for supporting the upper panel 540 in the extended position, is shown. The extended position, when referring to the upper panel 540, includes the position that the upper panel will occupy when the ramp is extended, whether the lower ramp and mid ramp are in the extended position or not. In certain embodiments, rotation limiters comprise a support leg 505 coupled to the upper panel 540 for supporting the ramp 500 in the extended position, wherein a distal portion 506 of the support leg 505 contacts the outside surface 520 when the ramp 500 is in the extended position. The support leg 505 may be coupled to the upper panel 540 at the support coupling element 525. Any suitable coupling method may be used, such as, for example, screws, bolts, rivets, or welds.

The support leg 505 may be coupled to the upper panel 540 at any suitable position along the length of the upper panel 540. For example, in some embodiments, the support leg 505 may be coupled to the upper panel 540 at or in close proximity to the end of the upper panel 540 that is adjacent the mid panel.

The support leg 505 may pass through openings in the lower access gate 550. In some embodiments, multiple support legs 505 may be used. The support leg 505 may limit the upper panel 540 from rotating down past the extended position and may provide support for holding the upper panel 540 in the extended position. The support leg 505 may strengthen the ramp 500 against buckling failure. The support leg 505 may also strengthen the ramp 500 against buckling failure at the joint between the upper panel 540 and the mid panel.

Any suitable latching mechanism may be used to hold the lower access gate closed and to open it. In some embodiments, a handle or lever may be coupled to the latching or opening mechanism of the lower gate for releasing the lower gate for opening.

Referring again to FIG. 1B, in certain embodiments, the upper panel 140 may be coupled to one or more handles 175 for lowering or raising the ramp 100 in the stacked position 110 once the ramp 100 is released and free to rotate between the upright position and a lowered position. In embodiments where the ramp 100 is coupled to the lower gate 170, the handles 175 may be used to lower or raise both the ramp 100 and the lower gate 170.

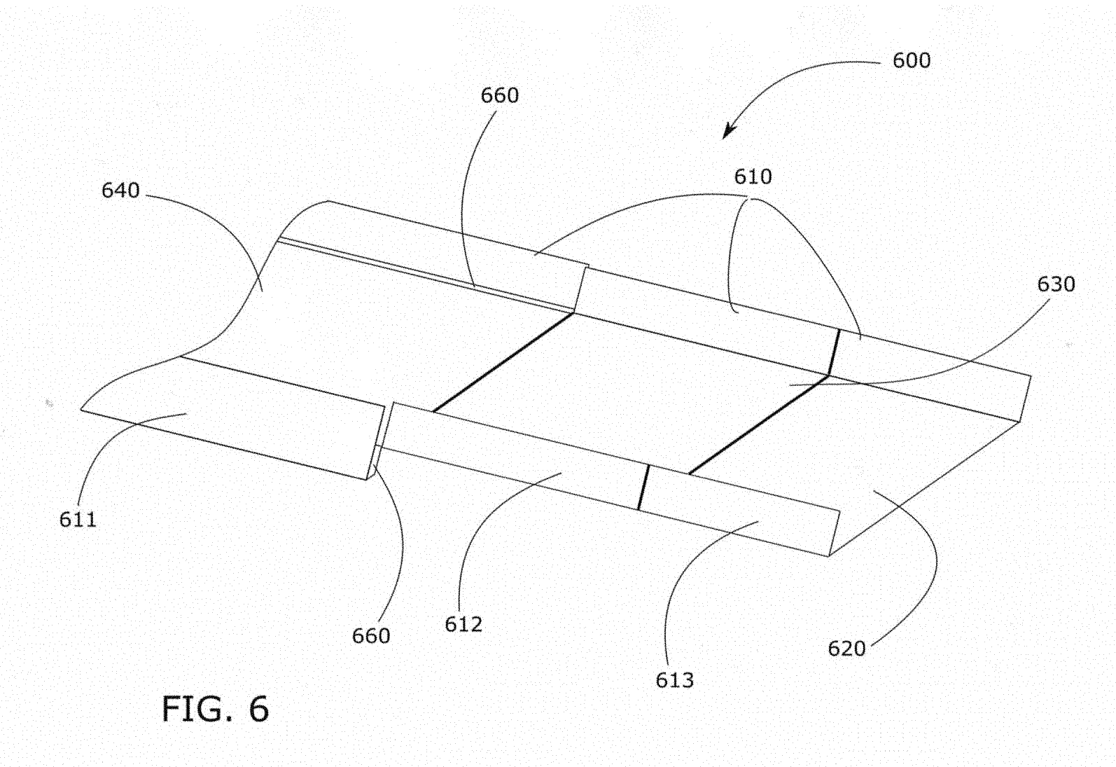

Referring to FIG. 6, an embodiment of a stowable ramp 600 with attached side rails 610 is shown. Side rails 610 running along either side of the ramp 600 act as a safety barrier for impeding a wheelchair from rolling off of a side of the ramp 600. The side rails 610 extend above a top surface of the ramp 600. The side rails 610 may include a first set 611 of side rails coupled to the upper panel 640, a second set 612 of side rails coupled to the mid panel 630, and a third set 613 of side rails coupled to the lower panel 620.

In some embodiments, the upper panel 640 may include a slot 660 on either side adjacent to an inner side of the one or more side rails 611 for receiving the one or more side rails 612 of the mid panel when the ramp 600 is in the stacked position. Any suitable type of slots may be used. For example, in certain embodiments, the slots 660 may be grooves. The grooves may be of a depth to accommodate the mid panel side rails 612. An outer wall of the grooves may be formed by the upper panel side rails 611, which may extend down below the top surface of the upper panel 640 to a depth suitable for receiving the mid panel side rails 612. An inner wall of the grooves may be attached to the planar surface of the upper panel 640. A bottom or floor portion may join the outer wall of the groove to the inner wall. Each groove may have any suitable width and length to accommodate receiving the mid panel side rails 612. For example, in some embodiments, the groove may run the entire length of the upper panel 640.

In some embodiments, the slots 660 may be gaps between the top surface of the upper panel 640 and the upper panel side rails 611. The upper panel side rails 611 may be attached to the planar surface of the upper panel 640 at the front and back edges of the panel, such that the gap does not extend the entire length of the upper panel 640. For example, a portion of the upper panel 640 may extend across the gap and be welded to the upper panel side rails 611. Alternatively, a bar or rod may be used to couple the upper panel side rails 611 to the upper panel 640 across the gap. The mid panel side rails 612 may be shorter than the length of the mid panel 640 in order to fit into the gaps between the upper panel side rails 611 and the upper panel 640. In certain embodiments, the upper panel side rails 611 may be coupled to the upper panel 640 across the gap at additional points between the ends of the upper panel 640. In these embodiments, the mid panel side rails 612 may include breaks corresponding to the coupling points across the gap in the upper panel 640.

The upper panel 640 may be wider than the mid panel 630 to accommodate the slots 660. When the ramp 600 folds into the stacked position with the top surface of the upper panel 640 facing the top surface of the mid panel 640, the side rails 612 fit into the slots 660, making the stacked position of the ramp 600 more compact. Tabs or stoppers may be attached to the to the side rails such that the tabs or stoppers extend above or below the side rails. The tabs or stoppers may separate the side rails from contacting the surface of the panel that the side rails rest against when the ramp is in the stacked position. For example, tabs attached to the top of the side rails attached to the mid panel may act as a cushion or separating element between the mid panel side rails and the upper panel. The tabs or stoppers may be made of any suitable material, including, for example, rubber and plastic. Additionally, the tabs or stoppers may have any suitable shape.

In certain embodiments, each of the upper panel, the mid panel, and the lower panel are coupled on either side to one or more side rails, each side rail extending vertically upwards relative to a top planar surface of the panel that the side rail is coupled to such that the ramp in the extended position has side rails on either side for impeding a wheel of a wheelchair from rolling off of a side of the ramp.

Any suitable railing may be used as a side railing. For example, in certain embodiments, solid plates or panels may be used. Alternatively, the plates may have holes or cut-outs in them. In some embodiments, bars or rods may be used as a railing. A mesh or grating may also be used. The side rails may have any suitable height and thickness dimensions. For example, in some embodiments, the side railings may extend about 1 to 4 inches above the surface of the panel they are coupled to. In certain embodiments, they side railings may extend higher.

Any suitable material may be used for the railing. For example, in some embodiments, the side railings may be made of a metal, such as steel or aluminum. In certain embodiments, composite materials, such as carbon fibre or fibreglass, may be used.

The side railings may also act as rotation limiters or have rotation limiters coupled to them. For example, in some embodiments, an end of the side railing on the mid panel may abut an end of the side railing on the lower panel when the mid panel and lower panel are in ramp alignment, holding the panels in ramp alignment by limiting further rotation in a direction away from the stacked position of the ramp.

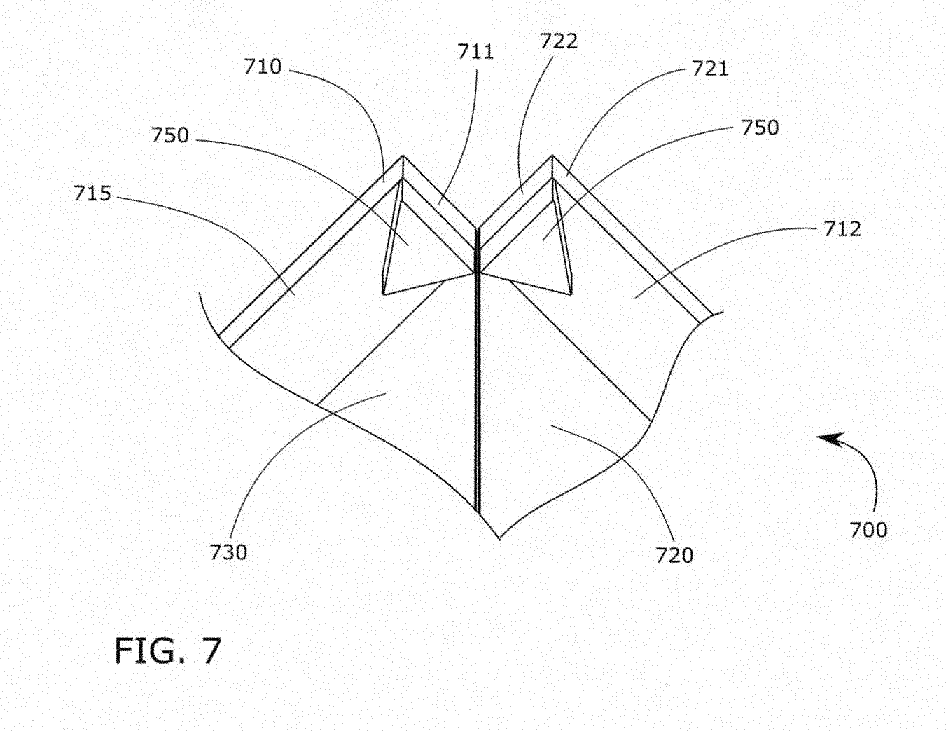

Referring to FIG. 7, in certain embodiments, the rotation limiters include an end piece 710 of one or more side rails 715 coupled to the mid panel 730, the end piece 710 being adjacent to the lower panel 720 when the ramp 700 is in the extended position, wherein the end piece 710 has a load bearing surface 711 for bearing against a complimentary load bearing surface 722 of a complimentary end piece 721 on a side rail 712 of the lower panel 720 when the ramp 700 is in the extended position.

The end piece 710 and the complimentary end piece 721 may be thickened to increase the stiffness and strength of the end piece 710 and complimentary end piece 721, as well as the size of the load bearing surfaces 711, 722. In some embodiments, the end piece 710 is thickened relative to a mid portion of the one or more side rails 715 coupled to the mid panel 730 and the complimentary end piece 721 is thickened relative to a mid portion of the one or more side rails 712 coupled to the lower panel 720, thereby increasing the surface areas of the load bearing surface 711 and the complimentary load bearing surface 722.

Any suitable thickening method may be used. For example, in certain embodiments, small plates 750 may be fixed to the end portions to increase the thickness of the end piece 710 and complimentary end piece 721. The small plates 750 may be fixed to the end piece 710 and complimentary end piece 721 with the planar faces of the small plates 750 parallel to the planar faces of the side railings 712, 715, as shown in FIG. 7. The load bearing surface 711 may then have a thickness equal to the combined thickness of the end piece 710 and the small plate 750. Similarly, the complimentary load bearing surface 722 may then have a thickness equal to the combined thickness of the complimentary end piece 721 and the small plate. Alternatively, small plates or blocks with a wider load bearing surface than the either the end piece or the complimentary end piece may replace the ends of the end piece and complimentary end piece. The small plates may be fixed to the side rails using any suitable attachment method, such as, for example, welding or bolting. In some embodiments, the end portions of the side rails may be thickened during the manufacturing process by, for example, extruding, casting, or forging the side rails to have a larger thickness at an end than in the middle.

Having the mid panel and lower panel side rails have a thicker portion at the ends where they contact each other in the ramp aligned position decreases the possibility of the side railings sliding past each other. Additionally, the larger bearing surfaces and increased strength of the end portions of the side rails adds to the load bearing capacity of the ramp. The possibility of the ramp buckling at the joint between the lower panel and the mid panel may be reduced.

In some embodiments, the load bearing surface may be located on an extension of the end piece of the mid panel. The extension may be received in a slot in the complimentary end piece of the lower panel when the ramp is in the extended position. Alternatively, the extension with the load bearing surface may be coupled to the lower panel and the slot may be on the mid panel.

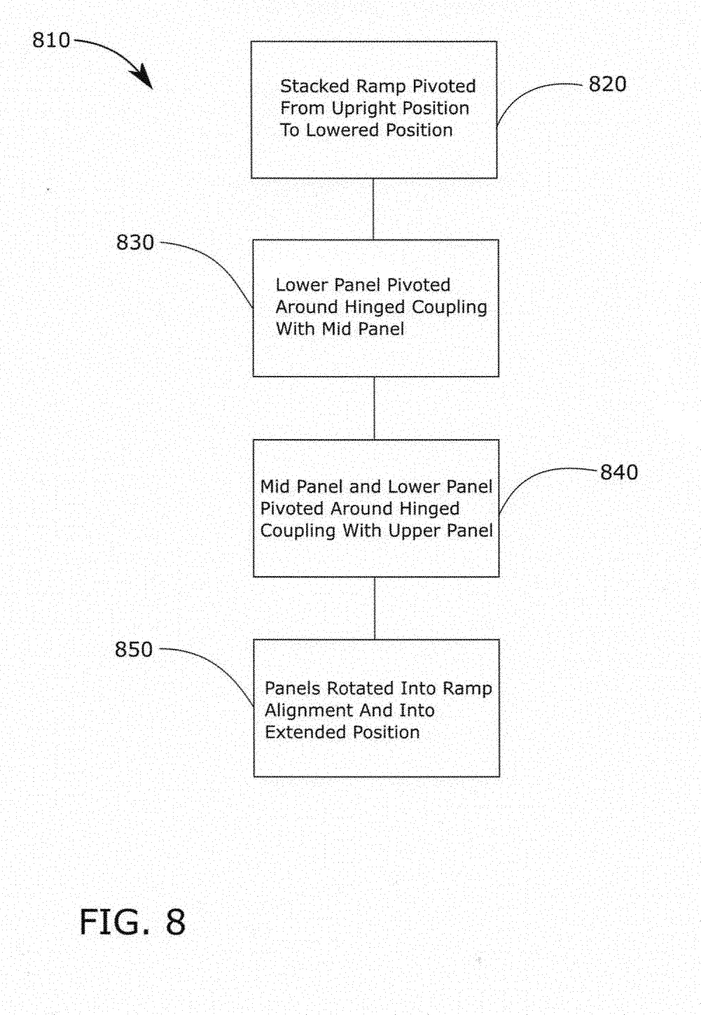

Referring to FIG. 8, an embodiment of a method for extending a wheelchair access ramp mounted to a vehicle from a stacked position to an extended position is shown at 810. At box 820, a stack of ramp panels is pivoted down from an upright position to a lowered position. The lowered position corresponds to the position of the upper panel in the extended position. At box 830, the lower panel is rotated around a hinged coupling that couples the lower panel to the mid panel. At box 840, the mid panel, along with the lower panel, is rotated around a hinged coupling that couples the mid panel to the upper panel, while the lower panel continues to be rotated around the coupling between the lower panel and the mid panel. At box 850, the panels are rotated into ramp alignment position and the lower edge of the lower panel is placed against the ground. For moving the ramp from the extended position to the stowed position, the method shown in FIG. 8 may be reversed.

In certain embodiments, a method for extending a wheelchair access ramp from a stacked position in a vehicle to an extended position extending from an entry port of the vehicle to an exterior surface includes pivoting a stack of ramp panels from an upright position to a lowered position. The stack comprises a mid panel between an upper panel and a lower panel, the upper panel being positioned closest to a floor of the vehicle and having a bottom planar surface facing towards the floor of the vehicle when the stack is in the lowered position. The mid panel is coupled to the upper panel at a first end and to the lower panel at a second end and the upper panel is coupled to the vehicle at a vehicle coupling position distal to the first end. The method also includes rotating the lower panel around a pivoting joint that couples the lower panel to the mid panel and rotating both the lower panel and the mid panel around a pivoting joint that couples the mid panel to the upper panel until top surfaces of all three panels are aligned to form a ramp extending from the vehicle to the exterior surface. Rotation limiters coupled to two or more of the ramp panels maintain the ramp in the extended position by limiting rotation of the ramp panels from the upright position to the extended position. In some embodiments, the rotation limiters may include an upper panel support spaced apart from the vehicle coupling position for supporting the upper panel in the lowered position.

In some embodiments, the rotation limiters include a rotation limiting portion of the mid panel and a rotation limiting portion of the lower panel. The rotation limiting portion of the mid panel engages with the rotation limiting portion of the lower panel for limiting rotation of the lower panel between the lowered position and the extended position.

### Use

According to some embodiments, a user may manually extend the ramp when the vehicle is parked and ready to receive a passenger in a wheelchair or scooter. For a rear mounted access ramp, the user opens a back door or hatch of the vehicle, exposing the top of the upright stowed ramp. The user may then unlatch the lower access gate that the stowable ramp may be mounted to and may lower the access gate and attached stowed ramp using a handle coupled to the upper panel of the ramp. The user may then grasp a handle attached to the lower panel and pull the handle up and out towards the user. The lower panel will rotate up from the mid panel and the mid panel will begin to rotate about its hinged connection with the upper panel. The user may continue pulling the handle until the panels are unfolded and almost in ramp alignment and may then rest the lower edge of the lower panel against the ground. The lower panel and mid panel may be in ramp alignment prior to the user lowering the lower panel to the ground by rotating the mid panel and the lower panel around the hinged connection between the upper panel and the mid panel. Alternatively, the lower edge of the lower panel may be resting against the ground before the lower panel and the mid panel are in ramp alignment. In this case, the user may move the lower panel into ramp alignment with the mid panel by, for example, pulling the lower edge of the lower panel forward along the ground. Alternatively, the user may provide a downwards force on the mid panel by, for example, stepping down on the mid panel, causing the lower edge of the lower panel to slide forward on the ground until the mid panel and the lower panel are in ramp alignment.

To stow the ramp, in accordance with certain embodiments, the user may grasp the handle attached to the lower panel and lift upwards, rotating the mid panel and the lower panel around the hinged connection between the upper panel and the mid panel. The user may then apply a force backwards towards the vehicle or twist downwards while still pushing upwards, causing the lower panel to rotate downwards around the hinged connection between the mid panel and the lower panel. The user may continue lifting while pushing the handle towards the vehicle until the mid panel folds down against the upper panel and the lower panel folds down against the mid panel. The user may then lift the lower access gate and the attached upper panel using the handle extending from the upper panel. The user may close the lower access gate, thus moving the stacked ramp into an upright position. A latching system may hold the lower access gate closed. The user may then close the rear vehicle door.

### Alternatives

In some embodiments, the stowable ramp may move between the stacked position and the extended position using sliding or rolling panels. For example, the upper panel, as part of the stacked ramp, may be lowered to a generally horizontal position relative to the floor of the vehicle. From this position, the mid panel with the lower panel stacked against it may be slid out relative to the outer panel until the edge of the mid panel that is adjacent the upper panel in the extended position is positioned adjacent the distal edge of the upper panel (distal relative to the vehicle). The mid panel may, in this position, be positioned above the upper panel in some embodiments and below the upper panel in other embodiments, depending on if the mid panel was above or below the upper panel in the stacked position. The mid panel, with the lower panel, may then be pivoted into ramp alignment with the upper panel. Similarly, the lower panel may then be slid or rolled out relative to the mid panel and then pivoted into ramp alignment. The entire ramp may then be pivoted down around a connection point of the upper panel and the vehicle and into the extended position. Alternatively, the upper panel, as part of the stacked ramp, may initially be lowered to a position corresponding to the position of the upper panel in the extended position, with the upper panel being inclined towards an outside surface rather than generally parallel to the floor of the vehicle. Sliding and pivoting the mid ramp and the lower ramp into ramp alignment will bring the ramp into the extended position.

In the aforementioned embodiments, any suitable sliding and pivoting connection method may be used to couple the upper panel to the mid panel and the mid panel to the lower panel. For example, in certain embodiments, a linking bar may be pivotally connected to a side edge of the mid panel proximate to the distal end of the upper panel when the ramp is in the extended position. The other end of the linking bar may be coupled to a wheel adapted to roll in a track coupled to the side of the upper panel. The linking bar may be pivotally coupled to the wheel, allowing the wheel to freely rotate relative to the link. The opposite sides of the upper panel and the mid panel may be similarly linked. A similar linkage system may couple the lower panel and the mid panel.

Some embodiments of the stowable ramp may use a system of actuators, gears, and/or belts and pulleys to move the ramp between a stowed position and an extended position, as opposed to a user manually moving the ramp. Separate actuators may be used at each joint or a single actuator may be used to power rotation at all of the pivoting joints. The actuators may be powered by any suitable power source, such as, for example, the vehicle's battery. Alternatively, a separate battery may be used.

Any suitable method for initiating extension or stowage of powered ramps may be used. For example, in certain embodiments, a switch proximate to the ramp may be used. In some embodiments, a switch in the vehicle cockpit or in the passenger area of the vehicle may be used. A switch or button may also be located on a remote device, such as a key fob, for remotely activating the ramp.

It is contemplated that any part of any aspect or embodiment discussed in this specification can be implemented or combined with any part of any other aspect or embodiment discussed in this specification.

While particular embodiments have been described in the foregoing, it is to be understood that other embodiments are possible and are intended to be included herein. It will be clear to any person skilled in the art that modifications of and adjustments to the foregoing embodiments, not shown, are possible.

1. A stowable ramp for providing wheelchair access to a vehicle, the stowable ramp extendable between a stacked position and an extended position extending from an entry port of the vehicle to an outside surface, the stowable ramp comprising:
(a) an upper panel for forming an upper part of the stowable ramp, the upper panel comprising a vehicle coupling element for coupling the upper panel to the vehicle at the entry port;
(b) a mid panel for forming a middle part of the stowable ramp and hingedly coupled to the upper panel for pivoting the mid panel into ramp alignment with the upper panel during extension of the stowable ramp; and
(c) a lower panel for forming a lower portion of the stowable ramp and hingedly coupled to the mid panel for pivoting the lower panel into ramp alignment with the mid panel during extension of the stowable ramp;
wherein at least two of the upper panel, the mid panel, and the lower panel are coupled to rotation limiters for limiting rotation of the upper panel, the mid panel, and the lower panel collectively between the stacked position and the extended position and wherein the upper panel, mid panel, and lower panel stack atop each other for stowing in the stacked position.

2. The stowable ramp of claim 1 further comprising a first hinge positioned between adjacent ends of the upper panel and the mid panel for hingedly coupling the upper panel to the mid panel and a second hinge positioned between adjacent ends of the mid panel and the lower panel for hingedly coupling the mid panel to the lower panel.

3. The stowable ramp of claim 2 wherein the stowable ramp in the stacked position is stowable in an upright position relative to a floor of the vehicle, wherein in the upright position, a bottom planar surface of the upper panel faces the entry port.

4. The stowable ramp of claim 3 wherein the rotation limiters comprise an abutting portion of the lower panel for abutting against an abutting portion of the mid panel when the stowable ramp is in the extended position.

5. The stowable ramp of claim 4 wherein the rotation limiters comprise a projection extending from the mid panel for bearing against a surface of the lower panel when the stowable ramp is in the extended position.

6. The stowable ramp of claim 5 wherein the rotation limiters comprise a projection extending from the lower panel for bearing against a surface of the mid panel when the stowable ramp is in the extended position.

7. The stowable ramp of claim 6 wherein each of the upper panel, the mid panel, and the lower panel are coupled on either side to one or more side rails, each side rail extending vertically upwards relative to a top planar surface of the panel that the side rail is coupled to such that the stowable ramp in the extended position has side rails on either side for impeding a wheel of a wheelchair from rolling off of a side of the stowable ramp.

8. The stowable ramp of claim 7 wherein the rotation limiters comprise an end piece of the one or more side rails coupled to the mid panel, the end piece being adjacent to the lower panel when the stowable ramp is in the extended position, wherein the end piece has a load bearing surface for bearing against a complimentary load bearing surface of a complimentary end piece on a side rail of the lower panel when the stowable ramp is in the extended position.

9. The stowable ramp of claim 8 wherein the end piece is thickened relative to a mid portion of the one or more side rails coupled to the mid panel and the complimentary end piece is thickened relative to a mid portion of the one or more side rails coupled to the lower panel, thereby increasing surface areas of the load bearing surface and the complimentary load bearing surface.

10. The stowable ramp of claim 8 wherein the load bearing surface is located on an extension of the end piece and wherein the extension is received in a slot in the complimentary end piece when the stowable ramp is in the extended position.

11. The stowable ramp of claim 10, wherein the upper panel comprises a slot on either side adjacent to an inner side of the one or more side rails for receiving the one or more side rails of the mid panel when the stowable ramp is in the stacked position.

12. The stowable ramp of claim 1 wherein the rotation limiters comprise a second vehicle coupling element on the upper panel spaced apart from the vehicle coupling element for rigidly fixing the upper panel to the vehicle entry port.

13. The stowable ramp of claim 1 wherein the upper panel is rigidly fixable via the vehicle coupling element to a lower access gate of the vehicle at the entry port such that the stowable ramp in the stacked position is stacked on the lower access gate and moveable in conjunction with the lower access gate between a position corresponding to the position of the upper panel when the stowable ramp is in the extended position and a position that is an upright position relative to the floor of the vehicle.

14. The stowable ramp of claim 1 wherein the rotation limiters comprise a support leg coupled to the upper panel for supporting the stowable ramp in the extended position, wherein a distal portion of the support leg contacts the ground when the stowable ramp is in the extended position.

15. The stowable ramp of claim 1 wherein the stowable ramp is foldable into the stacked position by pivoting the lower panel and the mid panel around a first axis at which the upper panel is hingedly coupled to the mid panel and pivoting the lower panel around a second axis at which the lower panel is hingedly coupled to the mid panel such that in the stacked position, a bottom face of the lower panel is adjacent a bottom face of the mid panel and a top face of the mid panel is adjacent a top face of the upper panel.

16. A system for providing wheelchair access to a vehicle for transporting passengers in wheelchairs or scooters, the system comprising:
(a) a vehicle comprising a passenger compartment for receiving a passenger in a wheelchair and an entry port for providing a passenger in a wheelchair entry into and out of the vehicle;
(b) a stowable ramp mountable at the entry port for providing wheelchair access to the vehicle, the stowable ramp extendable between a stacked position and an extended position extending from the entry port of the vehicle to an outside surface, the stowable ramp comprising:
(i) an upper panel for forming an upper part of the stowable ramp, the upper panel comprising a vehicle coupling element for coupling the upper panel to the vehicle at the entry port;
(ii) a mid panel for forming a middle part of the stowable ramp and hingedly coupled to the upper panel for pivoting the mid panel into ramp alignment with the upper panel during extension of the stowable ramp; and
(iii) a lower panel for forming a lower portion of the stowable ramp and hingedly coupled to the mid panel for pivoting the lower panel into ramp alignment with the mid panel during extension of the stowable ramp;
wherein at least two of the upper panel, the mid panel, and the lower panel are coupled to rotation limiters for limiting rotation of the upper panel, the mid panel, and the lower panel collectively between the stacked position and the extended position and wherein the upper panel, mid panel, and lower panel stack atop each other for stowing in the stacked position.

17. The system of claim 16 further comprising a lower access gate at the entry port, the lower access gate openable downwards, wherein the stowable ramp is mounted to the lower access gate such that the stowable ramp in the stacked position is stacked on the lower access gate and moveable in conjunction with the lower access gate between a position corresponding to the extended position of the upper panel and a position that is an upright position relative to the floor of the vehicle.

18. A method for extending a wheelchair access ramp from a stacked position in a vehicle to an extended position extending from an entry port of the vehicle to an outside surface, the method comprising:
(a) pivoting a stack of ramp panels from an upright position to a lowered position, the stack comprising a mid panel between an upper panel and a lower panel, the upper panel being positioned closest to a floor of the vehicle and having a bottom planar surface facing towards the floor of the vehicle when the stack is in the lowered position, wherein the mid panel is coupled to the upper panel at a first end and to the lower panel at a second end and the upper panel is coupled to the vehicle at a vehicle coupling position distal to the first end; and
(b) rotating the lower panel around a pivoted joint that couples the lower panel to the mid panel and rotating both the lower panel and the mid panel around a pivoting joint that couples the mid panel to the upper panel until top surfaces of all three panels are aligned to form a ramp extending from the vehicle to the exterior surface, wherein rotation limiters coupled to two or more of the ramp panels maintain the ramp in the extended position by limiting rotation of the ramp panels from the upright position to the extended position.

19. The method of claim 18 wherein the rotation limiters comprise an upper panel support spaced apart from the vehicle coupling position for supporting the upper panel in the lowered position.

20. The method of claim 19 wherein the rotation limiters comprise a rotation limiting portion of the mid panel and a rotation limiting portion of the lower panel, the rotation limiting portion of the mid panel engaging with the rotation limiting portion of the lower panel for limiting rotation of the lower panel between the lowered position and the extended position.
